(19) United States
(12) Patent Application Publication
(10) Pub. No.: US 2021/0061677 A1
(43) Pub. Date: Mar. 4, 2021

(54) SYSTEMS AND METHODS FOR REAL-TIME MONITORING OF WATER PURIFICATION DEVICES

(71) Applicant: Christopher Ryan Bash, Walnut Creek, CA (US)

(72) Inventor: Christopher Ryan Bash, Walnut Creek, CA (US)

(21) Appl. No.: 16/550,738

(22) Filed: Aug. 26, 2019

(51) Int. Cl. C02F 1/00; C02F 9/00; G01N 27/416; G06N 5/04

(52) U.S. Cl. CPC C02F 1/008; C02F 9/00; C02F 1/44; G06N 5/04; C02F 1/004; G01N 27/4166

(57) ABSTRACT

A method for real-time monitoring of a water purification apparatus includes obtaining a first Total dissolved solid (TDS) data, a first flow rate, and a first pressure data of unfiltered input water through a first sensor module. A second TDS data, a second flow rate, and a second pressure data of filtered water is obtained through a second sensor module. Thereafter, a third TDS data, a third flow rate, and a third pressure data of post-filtered water is obtained through a third sensor module. Later, data collected by the sensor modules is transmitted to a remote processor in real-time, and the received data is analysed in real-time. Finally, a predictive model of water behaviour and water quality of the water purification system is generated, using an Artificial Intelligence (AI) based process, based on the real-time quality analysis, and one or more user actions are suggested based on the predictive model.

### TECHNICAL FIELD

The present disclosure relates generally to water systems monitoring devices, and more particularly to real-time monitoring of water purification devices in home and commercial applications.

### BACKGROUND

Water purification is the process of removing undesirable chemicals, biological contaminants, suspended solids, and gases from water. Most water is purified and is disinfected for human consumption, but water purification may also be carried out for a variety of other purposes, including medical, pharmacological, chemical and industrial applications.

Reverse osmosis (RO) method of water purification is being widely used for purification of water, both at small scale, and large scale. An RO based water purification system can be installed at houses, or in industries. In the RO based water purification method, mechanical pressure is applied to an impure solution to force pure water through a semi-permeable membrane. The semi-permeable membrane has to be replaced at regular intervals of time, to ensure smooth functioning of corresponding RO purification system.

There exist handheld meters, that locally measure flow rates, and pressure of such water purification devices. There also exist devices that measure similar data, particularly Total dissolved solids (TDS) by EC and temperature. Total dissolved solids (TDS) is a common indicator of water quality and the performance of a water purification system. Flow rate is a measurement of the amount of water passing through a point along the water purification system, and pressure is water pressure at a given location.

However, there does not exist a single system that automatically checks and monitors the water purification systems in real-time. There is no real-time quality indication system for a water purification system. A water purification system can deteriorate over time, and neither the user, nor the service provider has an idea, until this system is physically tested. It is essential to maintain high quality water for customers all the time, and with many locations and systems under service, it is impossible to know this information currently and be able to accurately test a given water purification system remotely.

Hence, in view of the above, there exists a need for a system and method that enable real-time and remote monitoring of multiple parameters crucial to a water purification system performance in removing contaminates from source water.

### SUMMARY

According to a first aspect, an embodiment of the present disclosure provides a method for real-time monitoring of a water purification apparatus. The method includes obtaining a first Total dissolved solid (TDS) data, a first flow rate, and a first pressure data of unfiltered input water through a first sensor module installed at an input of a pre-filter module of the water purification apparatus. The method may further include obtaining a second TDS data, a second flow rate, and a second pressure data of filtered water through a second sensor module installed at an output of a filter membrane of the water purification apparatus. The method may further include obtaining a third TDS data, a third flow rate, and a third pressure data of post-filtered water through a third sensor module installed at an output of a post-filter module of the water purification apparatus. The method may further include transmitting data collected by the first, second, and third sensor modules to a remote processor in real-time. The method may further include analysing the received data by the remote processor in real-time. The method may further include generating a predictive model of water behaviour and water quality of the water purification system by the remote processor, using an Artificial Intelligence (AI) based process, based on the real-time quality analysis. The method may further include suggesting one or more user actions based on the predictive model.

According to a second aspect, an embodiment of the present disclosure provides a system for real-time monitoring of a water purification apparatus. The system further includes a sensor module configured to obtain a first Total dissolved solid (TDS) data, a first flow rate, and a first pressure data of unfiltered input water through a first sensor module installed at an input of a pre-filter module of the water purification apparatus, obtain a second Total dissolved solid (TDS) data, a second flow rate, and a second pressure data of filtered water through a second sensor module installed at an output of a filter membrane of the water purification apparatus, obtain a third Total dissolved solid (TDS) data, a third flow rate, and a third pressure data of post-filtered water through a third sensor module installed at an output of a post-filter module of the water purification apparatus, and transmit data collected by the first, second, and third sensor modules to a remote processor in real-time. The system may further include a remote processor configured to analyse the received data in real-time, generate a predictive model of water behaviour and water quality of the water purification system, use an Artificial Intelligence (AI) based process, based on the real-time quality analysis, and suggest one or more user actions based on the predictive model.

According to a third aspect, an embodiment of the present disclosure provides a water purification apparatus that includes a pre-filter module configured to receive incoming tap water, and output pre-filtered water, a filter membrane configured to receive pre-filtered tap water, and output filtered water, a water tank configured to store a predefined quantity of the filtered water, a post filter configured to receive filtered water, and output post-filtered water. The water purification apparatus further includes a sensor system configured to obtain a first Total dissolved solid (TDS) data, a first flow rate, and a first pressure data of unfiltered input water through a first sensor module installed at an input of the pre-filter module, obtain a second TDS data, a second flow rate, and a second pressure data of filtered water through a second sensor module installed at an output of the filter membrane, and obtain a third TDS data, a third flow rate, and a third pressure data of post-filtered water through a third sensor module installed at an output of the post-filter module. The water purification apparatus further includes a processor configured to analyse the data obtained by the sensor system in real-time, generate a predictive model of water behaviour and water quality of the water purification system, use an Artificial Intelligence (AI) based process, based on the real-time quality analysis, and suggest one or more user actions based on the predictive model.

Various embodiments of the present disclosure provide a method, a remote quality control and diagnostic system, and a predictive centre. The method includes interpreting the real-time data and analysing the health of particular components of the water purification system and overall system health.

The remote quality control and diagnostic system monitors critical aspects of a RO water purification system, and allows for real time data and analysis of various system components critical for providing pure water to the end user. The predictive centre performs predictive analysis of various system components, component health, system health, system performance, and/or actions needed to be taken either remotely of physically by a technician.

It will be appreciated that features of the present disclosure are susceptible to being combined in various combinations without departing from the scope of the present disclosure as defined by the appended claims.

### DESCRIPTION OF THE DRAWINGS

The summary above, as well as the following detailed description of illustrative embodiments, is better understood when read in conjunction with the appended drawings. For the purpose of illustrating the present disclosure, exemplary constructions of the disclosure are shown in the drawings. However, the present disclosure is not limited to specific methods and instrumentalities disclosed herein. Moreover, those in the art will understand that the drawings are not to scale. Wherever possible, like elements have been indicated by identical numbers.

Embodiments of the present disclosure will now be described, by way of example only, with reference to the following diagrams wherein:

FIG. 1 illustrates an environment wherein various embodiments of the present invention can be practiced;

FIG. 2A illustrates exemplary data of the first and second TDS, and a TDS score for a water purification apparatus, in accordance with an embodiment of the present disclosure;

FIG. 2B illustrates exemplary data of the second and third TDS₂ and TDS₃ and the second flow rate F₂, in accordance with an embodiment of the present disclosure;

FIG. 3 illustrates exemplary data of the first and second pressure, and a pressure score data, in accordance with an embodiment of the present disclosure;

FIG. 4A illustrates exemplary data of the first flow rate, the filter throughput score, and the filter throughput ratio for a water purification apparatus, in accordance with an embodiment of the present disclosure;

FIG. 4B illustrate how the second flow rate F₂ in comparison to the first flow rate F₁ is used to calculate the Membrane Efficiency Score, in accordance with an embodiment of the present disclosure;

FIG. 4C illustrate how a difference in the second and third flow rates affect the post-filter flow score, in accordance with an embodiment of the present disclosure.

FIG. 5 illustrates an exemplary flow graph for RO tank analysis and prediction for a water purification apparatus, in accordance with an embodiment of the present disclosure;

FIG. 6 illustrates an exemplary table illustrating tank, shut-off valve, and leak decision diagram for a water purification apparatus, in accordance with an embodiment of the present disclosure;

FIG. 7 illustrates building of an exemplary prediction model with observation and related actions, in accordance with an embodiment of the present disclosure;

FIG. 8 illustrates a decision tree matrix, in accordance with an embodiment of the present disclosure; and

FIG. 9 is a flowchart illustrating a method for real-time monitoring of one or more water purification apparatuses, in accordance with an embodiment of the present disclosure.

In the accompanying drawings, an underlined number is employed to represent an item over which the underlined number is positioned or an item to which the underlined number is adjacent. A non-underlined number relates to an item identified by a line linking the non-underlined number to the item. When a number is non-underlined and accompanied by an associated arrow, the non-underlined number is used to identify a general item at which the arrow is pointing.

### DESCRIPTION OF EMBODIMENTS

The following detailed description illustrates embodiments of the present disclosure and ways in which they can be implemented. Although some modes of carrying out the present disclosure have been disclosed, those skilled in the art would recognize that other embodiments for carrying out or practicing the present disclosure are also possible.

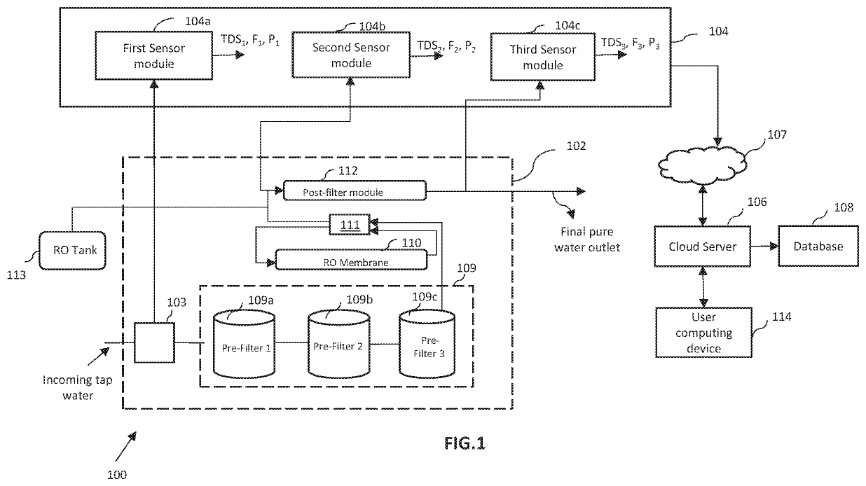

FIG. 1 illustrates an environment 100, wherein various embodiments of the present invention can be practiced. The environment 100 includes an RO based water purification apparatus 102, a sensor system 104 communicatively coupled to a cloud server 106 through a communication network 107, and an associated database 108. The environment 100 shows the overall water purification system design, water flow diagram, location of the sensor system, and the connection to cloud servers, database, and user computing devices. This visualizes the systems design, shows where each component is located, and explains the relationships between the system components.

The RO based water purification system 102 includes a receiver 103, a pre-filter module 109 that includes three pre-filters 109a till 109c, an RO membrane 110, a shut-off valve 111, a post filter 112, and an RO tank 113.

In operation, the pre-filter module 109 is configured to receive incoming tap water through the receiver 103 and output pre-filtered water. The shut-off valve 111 is connected between the third pre-filter 109c, and an input of the RO membrane 110 for managing the supply of the pre-filtered water to the RO membrane 110. The shut-off valve 111 is connected between an output of the RO membrane 110, and an input of the RO tank 113 for managing the supply of filtered water to the RO tank 113.

In the context of the present disclosure, the shut-off valve 111 is configured to automatically turn off the apparatus 102, when the RO tank 113 is filled with pure water. The shut-off valve 111 is a critical component to the proper functioning of the storage tank 113, and the RO membrane 110. If the shut-off valve 111 breaks, then water would continuously flow through the system, and out the drain line, and the pre-filter module 109 would be continuously in use and would wear out very quickly. Further, if the shut-off valve 111 is not shut off properly, the storage tank 113 could experience heightened levels of pressure and increased wear over time. It is also possible to experience zero water production from the apparatus 102, if the shut-off valve 111 is stuck closed, as water needs to pass through the valve 111 in order to have pure water.

The filtered water from the RO membrane 110 is provided to the post-filter module 112 through the RO tank 113. The post-filter module 112 may include one or more filters for performing post-filtration treatment of water. In one embodiment, the post filter module 112 may include a de-ionized filter for de-ionizing the filtered water, and zeroing down the TDS content of the de-ionized water. In another embodiment, the post filter module 112 may include an alkaline/re-mineralized filter for adding minerals to the filtered water, and increasing the TDS content of the filtered water. In an example, the alkaline filter adds calcium, and the re-mineralization filter adds other minerals such as iron.

The RO tank 113 is a pressure and storage tank used for holding pure water and maintains a pressure via a bladder system inside the tank 113. The RO tank 113 allows for more readily available water to the user on demand. In the context of the present disclosure, the shut-off valve 111 shuts off the water supply to the RO membrane 110 when the RO tank 113 is full to prevent the wastage of water. When the RO tank 113 fills, the pressure increases. When the pressure in the RO tank 113 reaches ⅔ of an inlet pressure of the RO membrane 110, the shut off valve 111 closes. When the water level reduces in the tank 113, the pressure decreases therein, and the shut-off valve 111 then opens, and water fills back into the RO tank 113 until it is full again.

The sensor system 104 includes first through third sensor modules 104a, 104b, and 104c to obtain one or more water parameters at initial, intermediate and final stages of the water purification. In an example, each of the first, second and third sensor modules 104a, 104b, and 104c may include one or more electrochemical sensors, that are configured to sense and obtain one or more water parameters such as total dissolved solids (TDS), flow rate, pressure, pH, conductivity, salinity, temperature, dissolved oxygen, free chlorine, arsenic, bacterial and other metals. In the context of the present disclosure, the sensor system 104 is configured to obtain only the TDS, flow rate and pressure data. Also, the sensor system 104 may include more than or less than three sensor probes. Although, the sensor system 104 is shown to include three sensor modules, it would be apparent to one of ordinary skill in the art, that the sensor system 104 may include more than or less than three sensor modules.

In an embodiment of the present disclosure, the first sensor module 104a is connected to the receiver 103, and configured to obtain a first TDS₁ (mg/l), a first flow rate F₁ (gallons/day) and a first pressure P₁ (psi) of received input water. The second sensor module 104b is connected to an input of the post filter 112, and configured to obtain a second TDS₂, a second flow rate F₂ and a second pressure P₂ of the filtered water generated by the RO membrane 110.

The third sensor module 104c is connected to an output of the post filter 112, and configured to obtain a third TDS₃, a third flow rate F₃ and a third pressure P₃ of the post-filtered water. When the post filter 112 is a de-ionized filter, a 0 TDS data is necessary for proper system function, and when the post filter 112 is an alkaline filter, a higher TDS data may be recorded because of additional minerals being added to the water.

Thus, the sensor system 104 is configured to obtain TDS data across three different locations of the RO system 102, to provide analysis on the RO membrane 110, and the post filter module 112. It is important to capture the TDS data both before and after the post-filter module 112 in order to predict and optimize its performance over time. The life-span of the post-filters of the module 112 are also directly related to corresponding TDS input levels.

The sensor system 104 is communicatively coupled to the cloud server 106 and the associated database 108 through the communication network 107. The communication network 107 may be any suitable wired network, wireless network, a combination of these or any other conventional network, without limiting the scope of the present disclosure. Few examples may include a Local Area Network (LAN), wireless LAN connection, an Internet connection, a point-to-point connection, or other network connection and combinations thereof.

In an embodiment of the present disclosure, the data of the sensor system 104 are collected in real-time and transmitted to the cloud server 106. The transmission process can be done via Wi-Fi signals, Blue-tooth signals, or other methods for sending and receiving data.

The cloud server 106 host the data and allows for the data to be accessible and usable by designated parties. In an embodiment of the present disclosure, the cloud server 106 includes a processor that receives the sensor data from the sensor system 104, and employ an artificial intelligence (AI) process to create a predictive model of water behavior and water quality for the end user. This process would deliver predictions based on the captured data and relationships of that data to predict events associated with the water system being monitored.

In an embodiment of the present disclosure, a user computing device 114 executes an application of the cloud server 106 to enable a user to manage and monitor the water purification system 100. Examples of the user computing device 114 include, but are not limited to a smart phone, a laptop, a desktop, and a personal computer. In an embodiment of the present disclosure, the website/application executing on the user computing device 114 enables access to different components of the collected data and can be customized as per user's requirements.

In an embodiment of the present disclosure, at the cloud server 106, the data is analyzed and the relationships between this data is analyzed to give a real-time quality analysis of a water system and therefore, the purity of the resulting water. This data is then sent into an AI platform to analyze and create predictive analysis of the water or systems in question.

Although one water purification apparatus 102 is being illustrated herein for the sake of brevity, it would be apparent to one of ordinary skill in the art, that the database 108 may store data from more than one individual water purification apparatus 102, and the cloud server 106 may conduct predictive analysis for multiple systems to understand which parts need to be changed or when the water quality is or will be not up standards.

In an embodiment of the present disclosure, the cloud server 106 uses the following models to monitor water quality and a water system performance:

### Model I

### Calculation of Overall Water Score (OWS)

OWS=s+t+u+v+w+x+y+z;

s=Membrane Efficiency Score=(Membrane Efficiency Ratio−Membrane Efficiency Rating)×10;
where, Membrane Efficiency Ratio=F₁/F₂

Membrane Efficiency Rating is provided by the manufacture for various RO Membranes. A 4:1 waste to affluent ratio membrane is designated as “5”. A 3:1 waste to affluent ratio membrane is designated as “4”.

F₁=First flow rate (gallons/day) obtained by the first sensor module 104a

F₂=Second flow rate (gallons/day) obtained by the second sensor module 104b

t=Post-Filter Pressure Score=(P₂−P₃)*10

P₂=Second pressure (psi) obtained by the second sensor module 104b

P₃=Third pressure (psi) obtained by the third sensor module 104c

u=Post-Filter Flow Score=(F₂−F₃)*10

F₃=Third flow rate (gallons/day) obtained by the third sensor module 104c

v=Post-Filter Life Score=(TDS₂+TDS₃)*F₂

TDS₂=Second TDS (mg/l) obtained by the second sensor module 104b

TDS₃=Third TDS (mg/l) obtained by the third sensor module 104c

F₂=Second flow rate obtained by the second sensor module 104b

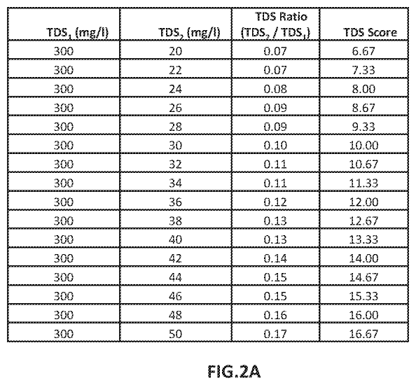

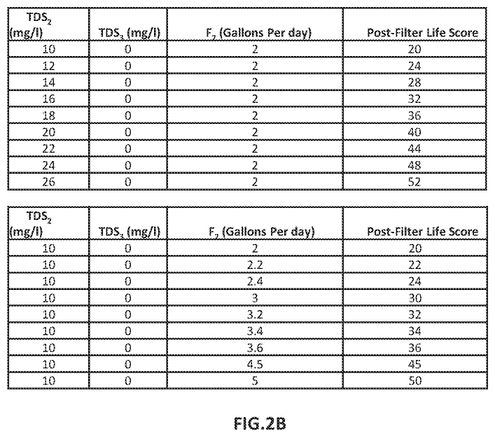

w=TDSScore=(TDS₂/TDS₁)×100;
where, TDS₁, and TDS₂ are TDS data obtained by the first and second sensor modules 104a and 104b respectively. A few exemplary data of the first and second TDS₁ and TDS₂, and a TDS score are illustrated with reference to FIG. 2A. The TDS score is derived from the TDS ratio. An increasing TDS score is associated with decreased water system performance. Further, FIG. 2B illustrates a few exemplary data of the second and third TDS₂ and TDS₃ and the second flow rate F₂ to show how increasing second TDS₂ and second flow rate F₂ affect a Post-Filter Life Score. An increasing Post-Filter Life Score signifies a decreased post filter performance and decreased overall water system health.

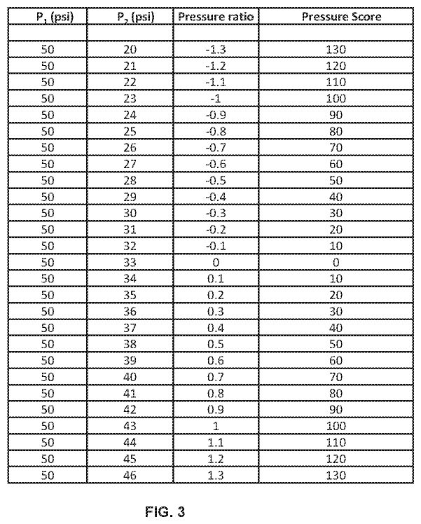

x=Pressure Score=((P₂−(aP₁))/(P₁−b)×100;
where, a=Ideal pressure loss, b=Minimum pressure required, P₁=Pressure before the RO membrane 110 obtained by the first sensor module 104a, and P₂=Pressure after the RO membrane 110 obtained by the second sensor module 104b. A few exemplary data of the first and second pressure P₁ and P₂ and the pressure score data are illustrated with reference to FIG. 3 showing how changes in the data of the second pressure P₂ affect the Pressure Score. An increasing pressure score signifies a decreasing water purification system performance.

y=Filter Throughput Score=[(Cumulative Gallons from F₁)/Gallons_{recommended})×100

z=Filter Time Score (Days_{used}/Days_{recommended})]×100
where,

Gallons_{recommended}=Average gallons recommended by a manufacturer for the pre-filter module 109

Cumulative Gallons from F₁=Number of gallons used by the pre-filter module 109

Days_{recommended}=No. of days recommended by the manufacturer for the pre-filter module 109

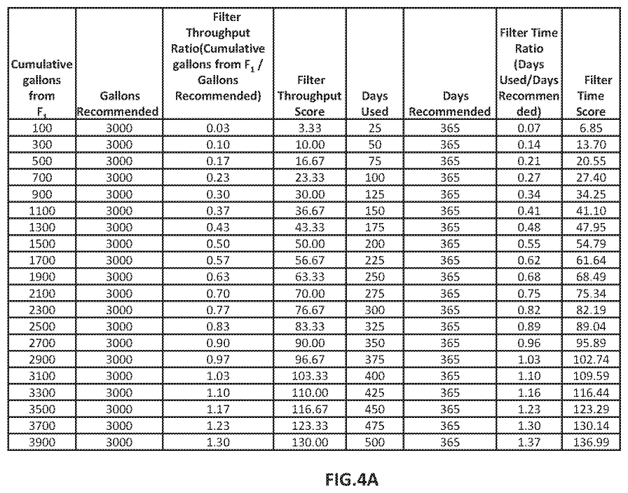

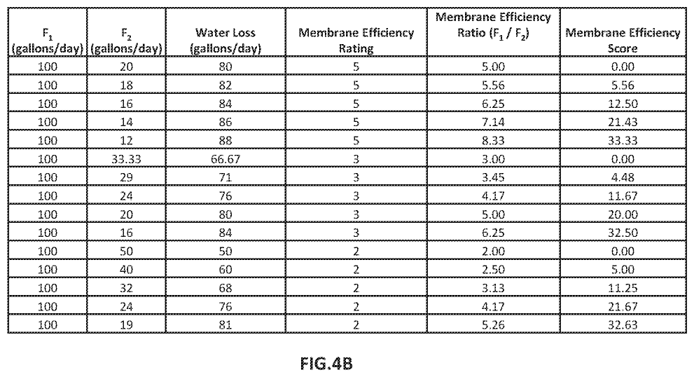

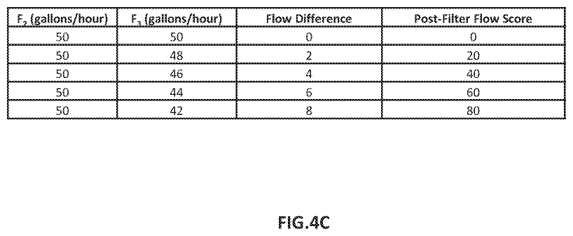

Days_{used}=Number of days for which the pre-filter module 109 is used. A few exemplary data of the cumulative gallons from F₁ and how an increasing cumulative gallons from F₁ effects the Filter Throughput Score is illustrated with reference to FIG. 4A. Also, shown is how an increase in days used affects a filter time score. Similarly, increased values of Days Used results in increased Filter Time Scores. An increase in Filter Time Scores signifies a decrease in water purification system performance.

Further, FIG. 4B shows how the data of the second flow rate F₂ in comparison to the data of the first flow rate F₁ are used to calculate the Membrane Efficiency Score. Also shown is the variable Membrane Efficiency Rating which is different depending on the RO membrane 110 in use. The Membrane Efficiency Rating is also used to calculate the Membrane Efficiency Score. A decreasing F2 data results in an increased Membrane Inefficiency Score. An Increased Membrane Inefficiency Score signifies a decrease in water purification system performance.

Also, it is shown with reference to FIG. 4C that how a difference in the second and third flow rates F₁ and F₂ affect the post-filter flow score. An increase in post-filter flow score signifies a decrease in water system performance.

Referring back to FIG. 1, the pre-filter module 109 removes various contaminants and are rated for a certain number of gallons of water throughput. The manufacturers recommend to change the pre-filters at certain time intervals. The filter time ratio takes this into account and allows for adjustments based on manufacture recommendations of time and/or through put.

In an embodiment of the present disclosure, the OWS may be monitored at regular intervals of time, such as every hour, or every day, to determine and analyze the rate of change of OWS over time and conduct a predictive process analysis based on the rate of change of OWS over time.

### Model II

### Calculation of Overall Water Score (OWS) Multivariable Score

OWS multivariable score=es+ft+gu+hv+aw+bx+cy+dz

Where, w=TDS ratio, x=Pressure ratio, y=Throughput ratio, and z=Filter Time Ratio, a=coefficient for TDS ratio, b=coefficient for Pressure ratio, c=coefficient for Throughput filter ratio, z=coefficient for Filter time ratio, e=coefficient for Membrane efficiency score, f=coefficient for Post-Filter Pressure Score, g=coefficient for Post-Filter Flow Score, h=coefficient for Post-Filter Life Score

a=% of weight to TDS

b=% of weight to Pressure

c=% of weight to Throughput filter ratio

d=% of weight to Filter time Ratio

e=% of weight to Membrane Efficiency Score

f=% of weight to Post-Filter Pressure Score

g=% of weight to Post-Filter Flow Score

h=% of weight to Post-Filter Life Score

In an example, a=30%, b=20%, c=10%, d=10%, e=5%, f=5%, g=5%, h=15%. The OWS multivariable score may be used to inform and create predictive analysis using Artificial Intelligence (AI) tools. The recommended range of these coefficients would be as follows. a=20-35% , b=20-30% , c=10-15% , d=5-15% , e=5-10% , f=5-10%, g=5-15%, h=10-20%

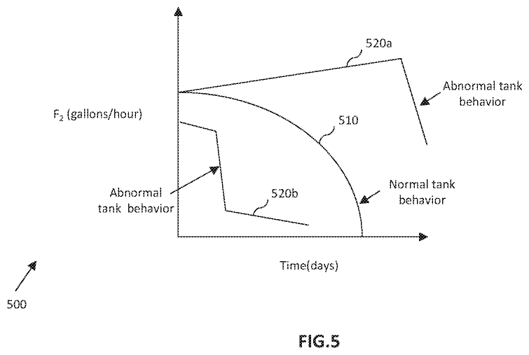

FIG. 5 illustrates an exemplary flow graph 500 for RO tank analysis and prediction, in accordance with an embodiment of the present disclosure. The flow curve 500 indicates behavior of flow data from the RO tank 113 over time to understand tank quality and predictive tank life. This is obtained by monitoring the second flow rate F₂ obtained by the second sensor module 104b. The flow graph 500 includes a first flow curve 510 that indicates normal tank behavior of a proper functioning tank and the second and third curves 520a and 520b indicate abnormal tank behavior of the RO tank 113 that is not functioning properly. Thus, the status of the RO tank 113 is an important function in the overhaul health of RO apparatus 102. The prediction methodology is also influenced from the RO tank 113 analysis as it is a critical component of the system functionality, drinking water availability and water purity. Abnormal tank behavior signifies a decreasing water system performance.

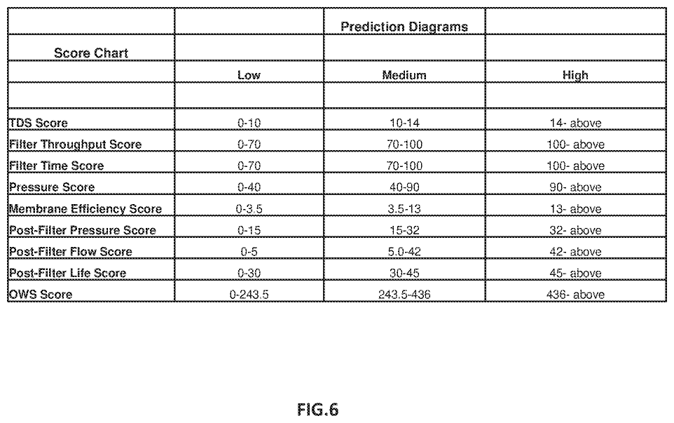

In an embodiment of the present disclosure, FIG. 6 illustrates various risk levels of real-time data such as TDS ratio, filter throughput ratio, filter time score, pressure ratio, and OWS score. The risk levels are then used to build a predictive model for the water purification apparatus 102.

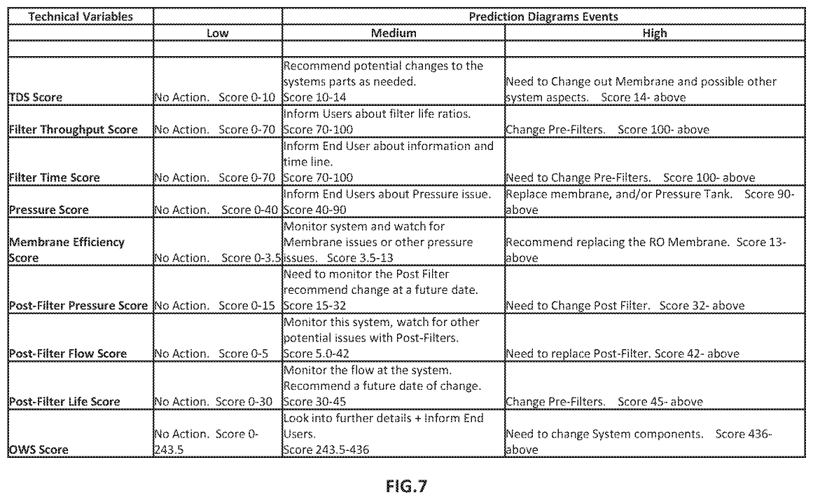

FIG. 7 illustrates how a prediction model may be built with observation and related actions. The predictive model includes various type of suggestive actions for low, medium and high risk levels of parameters such as TDS ratio, filter throughput ratio, filter time score, and OWS score.

An action may either be an informative action, which includes informing the user about the issue in one or more parts such as RO membrane 110, the pre-filter module 109, the post-filter module 112 such as, de-Ionized filter, alkaline filter, re-mineralization filter, pressure tank 113, water pipe, or the action may be a corrective action such as sending technician, shut off valve supply, replace the tank 113, check for leak, replace the pre-filter module 109, and replace the post-filter module 112, replace the RO membrane 110, and replace the shut-off valve 111.

In a first example, when pressure ratio increases to above 50, then a notification may be sent to the end user, and the corresponding water purification apparatus may be flagged, for a noticeable pressure issue that need fixing.

In a second example, when TDS ratio increases above 15, then a consumer or operator may be notified that the corresponding system is not functioning correctly, and maintenance is required. In a third example, when a post-filter life score is at 20, then no action may be needed.

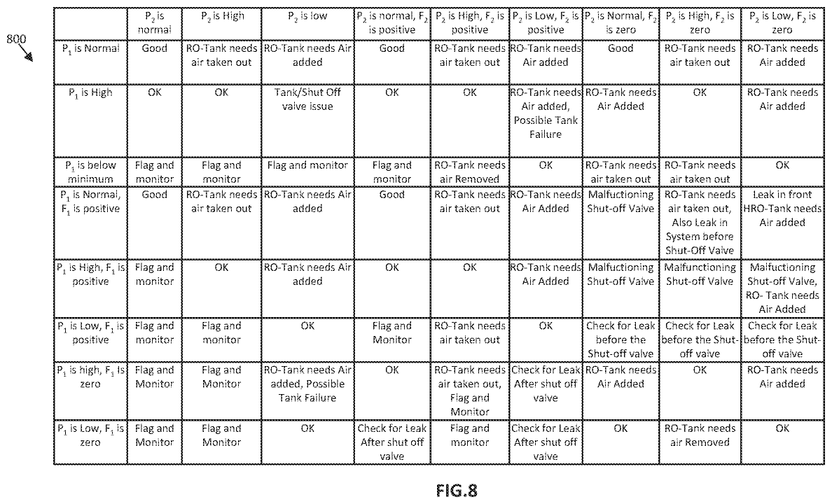

FIG. 8 illustrates a decision tree matrix 800, in accordance with an embodiment of the present disclosure. The decision tree matrix 800 is formed based on the database information analysis (see, FIG. 6) and the flow curve of RO tank (see FIG. 5). The decision tree matrix 800 describes actions needed to be taken for various recognized events and/or combination of events recognized in a particular system. This can be leak detection, tank malfunction, water quality decrease, required component replacement, etc. The decision tree matrix 800 may be used to generate predictive layers regarding pre-filter life, tank life, membrane life, post-filter life, leak prediction, and shut-off valve life.

Thus, the prediction methodology of the present disclosure facilitates in determining when the post-filter module 112 may break down, and effect end user water quality. The prediction methodology uses TDS data for determining the life span of post filters such as deionized filter, and alkaline water filter.

The prediction methodology of the present disclosure further facilitates in determining “pre-filter life”, i.e. life of the pre-filters installed before the RO membrane 110. The pre-filter life is also a crucial aspect of system design and functionality.

The prediction methodology of the present disclosure further analyses both pressure and flow from both sources (input tap water, and RO membrane) to identify the location of a leak and/or malfunctioning component such as the RO tank 113, and the shut-off valve 111.

Thus, the process of recording the electrochemical sensor data and applying combination scores based on relationships of the supplied data, and then incorporating AI platforms to analyze, learn, and develop predictions of outcomes relevant to water quality and water systems, can be extremely useful for enhancing water purification systems performance and water quality.

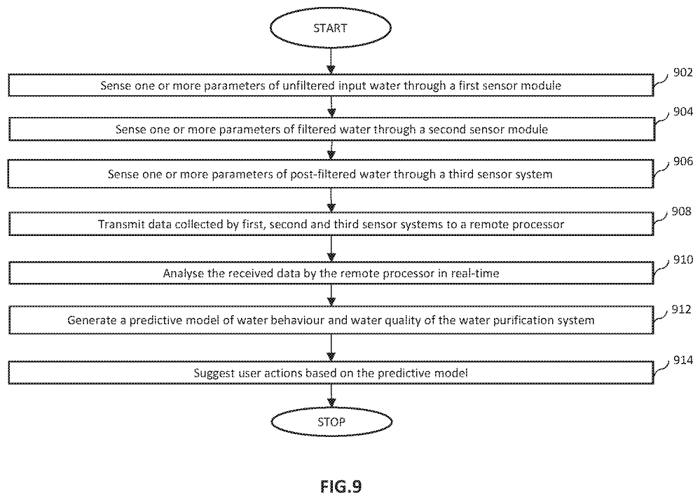

FIG. 9 is a flowchart illustrating a method for real-time monitoring of a water purification apparatus, in accordance with an embodiment of the present disclosure.

At step 902, one or more parameters of unfiltered input water are sensed through a first sensor module installed at an input of a pre-filter module of the water purification apparatus. At step 904, one or more parameters of filtered water are sensed through a second sensor module installed at an output of a filter membrane of the water purification apparatus. At step 906, one or more parameters of post-filtered water are sensed through a third sensor module installed at an output of a post-filter module of the water purification apparatus. The post-filter module includes at least one of: a de-ionized filter, an alkaline filter, and a re-mineralized filter. A zero TDS data of the de-ionized filter indicates a proper functioning of the de-ionized filter, and a non-zero data of the alkaline filter indicates a proper functioning of the alkaline filter.

In an embodiment of the present disclosure, a first Total dissolved solid (TDS) reading, a first flow rate, and a first pressure data of unfiltered input water are obtained through a first sensor module installed at an input of a pre-filter module of the water purification apparatus. Further, a second TDS data, a second flow rate, and a second pressure data of filtered water are obtained through a second sensor module installed at an output of a filter membrane of the water purification apparatus. Furthermore, a third TDS data, a third flow rate, and a third pressure data of post-filtered water are obtained through a third sensor module installed at an output of a post-filter module of the water purification apparatus.

At step 908, data collected by the first, second, and third sensor modules is transmitted to a remote processor in real-time. Each of the first, second and third sensor modules includes electrochemical sensors for obtaining each of the flow rate, TDS and pressure at one or more locations of the water purification apparatus.

At step 910, the received data is analysed by the remote processor in real-time. The analysing the received data includes calculating an overall water score (OWS) based on a TDS ratio, pressure ratio, throughput filter ratio, and filter time ratio. The TDS ratio is computed based on first and second TDS data obtained by the first and second sensor modules respectively, the pressure ratio is computed based on pressure data obtained before and after the filter membrane, the throughput filter ratio is computed based on average number of gallons of water recommended by the manufacturer, and the average number of gallons used by the pre-filter module, and the filter time ratio is computed based on number of days recommended by the manufacturer, and the number of days for which the pre-filter module is used.

At step 912, a predictive model of water behaviour and water quality of the water purification system is generated by the remote processor, using an Artificial Intelligence (AI) based process, based on the real-time quality analysis. The predictive model includes generating one or more predictions regarding water quality and one or more components of the water purification system based on low, medium, and high-risk levels of the OWS, the TDS ratio, the pressure ratio, the throughput filter ratio, and the filter time ratio. The predictive model includes one or more predictive layers regarding pre-filter life, tank life, membrane life, post-filter life, leak prediction, and shut-off valve life of the water purification system.

At step 914, one or more user actions are suggested based on the predictive model. The one or more user actions include an informative action and a corrective action.

The use of the terms “a” and “an” and “the” and similar referents in the context of describing the disclosure (especially in the context of the following claims) is to be construed to cover both the singular and the plural unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein is merely intended to serve as a shorthand method of referring individually to each separate value falling within the range, unless otherwise indicated herein, and each separate value is incorporated into the specification as if it were individually recited herein. All methods described herein may be performed in any suitable order unless otherwise indicated herein or otherwise clearly contradicted by context. The use of any and all examples, or exemplary language (e.g., “such as”) provided herein, is intended merely to better illuminate the disclosure and does not pose a limitation on the scope of the disclosure unless otherwise claimed. No language in the specification should be construed as indicating any non-claimed element as essential to the practice of the disclosure.

Modifications to embodiments of the invention described in the foregoing are possible without departing from the scope of the invention as defined by the accompanying claims. Expressions such as “including”, “comprising”, “incorporating”, “consisting of”, “have”, “is” used to describe and claim the present invention are intended to be construed in a non-exclusive manner, namely allowing for items, components or elements not explicitly described also to be present. Reference to the singular is also to be construed to relate to the plural. Numerals included within parentheses in the accompanying claims are intended to assist understanding of the claims and should not be construed in any way to limit subject matter claimed by these claims.

What is claimed is:

1. A method for real-time monitoring of a water purification apparatus, the method comprising:
obtaining a first Total dissolved solid (TDS) data, a first flow rate, and a first pressure data of unfiltered input water via a first sensor module installed at an input of a pre-filter module of the water purification apparatus;
obtaining a second TDS data, a second flow rate, and a second pressure data of filtered water through a second sensor module installed at an output of a filter membrane of the water purification apparatus;
obtaining a third TDS data, a third flow rate, and a third pressure data of post-filtered water through a third sensor module installed at an output of a post-filter module of the water purification apparatus;
transmitting data collected by the first, second, and third sensor modules to a remote processor in real-time;
analysing the received data by the remote processor in real-time;
generating a predictive model of water behaviour and water quality of the water purification system by the remote processor, using an Artificial Intelligence (AI) based process, based on the real-time quality analysis; and
suggesting one or more user actions based on the predictive model.

2. The method of claim 1, wherein the analysing the received data comprises calculating an overall water score (OWS) based on a membrane efficiency score, a post-filter pressure score, a post-filter flow score, a post-filter life score, a TDS score, a pressure score, a filter throughout score, and a filter time ratio.

3. The method of claim 2, wherein the membrane efficiency score is computed based on a ratio of first and second flow rate, the post-filter pressure score is computed based on the second and third pressure data, the post-filter flow score is computed based on the second and third flow rates, the post-filter life score is computed based on the second and third TDS data, and the second flow rate, the TDS score is computed based on the first and second TDS data, the pressure score is computed based on first and second pressure data, the filter throughput ratio is computed based on the first flow rate and average number of gallons of water recommended by the manufacturer, and the filter time score is computed based on number of days recommended by the manufacturer, and the number of days for which the pre-filter module is used.

4. The method of claim 2, wherein the generating the predictive model includes generating one or more predictions regarding water quality and one or more components of the water purification system based on low, medium, and high risk levels of the OWS, the membrane efficiency score, the post-filter pressure score, the post-filter flow score, the post-filter life score, the TDS score, the pressure score, the filter throughout score, and the filter time ratio.

5. The method of claim 4, wherein the predictive model includes one or more predictive layers regarding pre-filter life, tank life, membrane life, post-filter life, leak prediction, and shut-off valve life of the water purification system.

6. The method of claim 1, wherein the post filter module includes at least one of: a de-ionized filter, an alkaline filter, and a re-mineralized filter.

7. The method of claim 6, wherein a zero value of the third TDS data indicates a proper functioning of the de-ionized filter, and an increased value of the third TDS data indicates a proper functioning of the alkaline filter.

8. The method of claim 1, wherein each of the first, second and third sensor module includes electrochemical sensors for obtaining each of the flow rate, TDS and pressure at one or more locations of the water purification apparatus.

9. The method of claim 1, wherein the one or more user actions include an informative action and a corrective action.

10. A system for real-time monitoring of a water purification apparatus, the system comprising:
a sensor system configured to:
obtain a first Total dissolved solid (TDS) data, a first flow rate, and a first pressure data of unfiltered input water through a first sensor module installed at an input of a pre-filter module of the water purification apparatus;
obtain a second Total dissolved solid (TDS) data, a second flow rate, and a second pressure data of filtered water through a second sensor module installed at an output of a filter membrane of the water purification apparatus;
obtain a third Total dissolved solid (TDS) data, a third flow rate, and a third pressure data of post-filtered water through a third sensor module installed at an output of a post-filter module of the water purification apparatus; and
transmit data collected by the first, second, and third sensor modules to a remote processor in real-time; and
the remote processor configured to:
analyse the received data in real-time;
generate a predictive model of water behaviour and water quality of the water purification system, using an Artificial Intelligence (AI) based process, based on the real-time quality analysis; and
suggest one or more user actions based on the predictive model.

11. The system of claim 10, wherein the analysing the received data comprises calculating an overall water score (OWS) based on a membrane efficiency score, a post-filter pressure score, a post-filter flow score, a post-filter life score, a TDS score, a pressure score, a filter throughout score, and a filter time ratio.

12. The system of claim 11, wherein the membrane efficiency score is computed based on a ratio of first and second flow rate, the post-filter pressure score is computed based on the second and third pressure data, the post-filter flow score is computed based on the second and third flow rates, the post-filter life score is computed based on the second and third TDS data, and the second flow rate, the TDS score is computed based on the first and second TDS data, the pressure score is computed based on first and second pressure data, the filter throughput ratio is computed based on the first flow rate and average number of gallons of water recommended by the manufacturer, and the filter time score is computed based on number of days recommended by the manufacturer, and the number of days for which the pre-filter module is used.

13. The system of claim 11, wherein the generating the predictive model includes generating one or more predictions regarding water quality and one or more components of the water purification system based on low, medium, and high risk levels of the OWS, the membrane efficiency score, the post-filter pressure score, the post-filter flow score, the post-filter life score, the TDS score, the pressure score, the filter throughout score, and the filter time ratio.

14. The system of claim 13, wherein the predictive model includes one or more predictive layers regarding pre-filter life, tank life, membrane life, post-filter life, leak prediction, and shut-off valve life of the water purification system.

15. The system of claim 10, wherein the post filter module includes at least one of: a de-ionized filter, an alkaline filter, and a re-mineralized filter.

16. The system of claim 15, wherein a zero value of the third TDS data indicates a proper functioning of the de-ionized filter, and an increased value of the third TDS data indicates a proper functioning of the alkaline filter.

17. The system of claim 11, wherein each of the first, second and third sensor module includes electrochemical sensors for measuring each of the flow rate, TDS and pressure at one or more locations of the water purification apparatus.

18. The system of claim 11, wherein the one or more user actions include an informative action and a corrective action.

19. A water purification apparatus comprising:
a pre-filter module configured to receive incoming tap water, and output pre-filtered water;
a filter membrane configured to receive pre-filtered tap water, and output filtered water;
a water tank configured to store a predefined quantity of the filtered water;
a post filter configured to receive filtered water, and output post-filtered water;
a sensor system configured to:
obtain a first Total dissolved solid (TDS) data, a first flow rate, and a first pressure data of unfiltered input water through a first sensor module installed at an input of the pre-filter module; obtain a second TDS data, a second flow rate, and a second
pressure data of filtered water through a second sensor module installed at an output of the filter membrane; and
obtain a third TDS data, a third flow rate, and a third pressure data of post-filtered water through a third sensor module installed at an output of the post-filter module; and
a processor configured to:
analyse the data obtained by the sensor system in real-time;
generate a predictive model of water behaviour and water quality of the water purification system, using an Artificial Intelligence (AI) based process, based on the real-time quality analysis; and
suggest one or more user actions based on the predictive model.

20. The water purification apparatus of claim 19, wherein the analysing the received data comprises calculating an overall water score (OWS) based on a membrane efficiency score, a post-filter pressure score, a post-filter flow score, a post-filter life score, a TDS score, a pressure score, a filter throughout score, and a filter time ratio, and wherein the membrane efficiency score is computed based on a ratio of first and second flow rate, the post-filter pressure score is computed based on the second and third pressure data, the post-filter flow score is computed based on the second and third flow rates, the post-filter life score is computed based on the second and third TDS data, and the second flow rate, the TDS score is computed based on the first and second TDS data, the pressure score is computed based on first and second pressure data, the filter throughput ratio is computed based on the first flow rate and average number of gallons of water recommended by the manufacturer, and the filter time score is computed based on number of days recommended by the manufacturer, and the number of days for which the pre-filter module is used.
